(19) United States
(12) Patent Application Publication
(10) Pub. No.: US 2020/0332029 A1
(43) Pub. Date: Oct. 22, 2020

(54) BIOCOMPOSITE MATERIAL COMPRISING CNF AND AN ANIONIC GELLING POLYSACCHARIDE

(71) Applicant: Cellutech AB, Stockholm (SE)

(72) Inventors: Tobias Benselfelt, Sundbyberg (SE); Joakim Engstrom, Stockholm (SE); Lars Wagberg, Stockholm (SE)

(21) Appl. No.: 16/757,032

(22) PCT Filed: Oct. 17, 2018
(86) PCT No.: PCT/SE2018/051060

§ 371 Date: Apr. 17, 2020

(30) Foreign Application Priority Data
Oct. 17, 2017 (SE) 1751289-8

(51) Int. Cl. C08B 37/00; C08L 1/02; D21H 11/18; D21H 17/25; D21H 17/30; D21H 15/10

(52) U.S. Cl. CPC C08B 37/0084; C08L 1/02; D21H 11/18; B82Y 30/00; D21H 17/30; D21H 15/10; D21H 17/25

(57) ABSTRACT

A composite material comprising 65-99 wt % cellulose nanofibers and 0.5-30 wt % of an anionic gelling polysaccharide, as calculated by dry weight of the composite material, a method for preparing such composite material, and different applications and uses of the composite material.

### FIELD OF THE INVENTION

The present invention relates to a composite material comprising 65-99 wt % cellulose nanofibrils (CNF) and 0.5-30 wt % of an anionic gelling polysaccharide, as calculated by dry weight of the composite material. It further relates to a method for preparing such composite material, as well as the use of the composite material in packaging or as filaments.

### TECHNICAL BACKGROUND

Cellulose nanofibrils (CNF) are made of crystalline cellulose that forms high aspect ratio fibrils which are the fundamental load bearing structure in higher plants. CNFs are used in research towards many interesting material applications due to the nanoscale properties and the inherent strength of the cellulose crystal structure. Thanks to good barrier properties of films made from CNF, it is desirable to use CNF to compete with petro-chemical materials in for example the packaging industry, but also to utilize the nano-scale properties of CNF to develop processing routes to design high-end materials and devices. However, water acts as a plasticizer for polysaccharides such as cellulose, which means that the impressive properties of for example a CNF paper (nanopaper) are drastically changed when the material is exposed to water in condensed form or moist air. The preparation of CNF usually involves a modification step to introduce charged groups, such as carboxylic acids, sulphuric acids, or quaternary amines, to the surface of the CNF to facilitate the liberation of the fibrils from the pulp fibre and to improve the colloidal stability of the dispersion. This modification results in an even higher sensitivity to water as ionic swelling is added to the list of properties for the material prepared from CNF. Interaction with water and ionic swelling of CNF-based materials and composites can be an advantage when it comes to biodegradability but is in general a disadvantage during the lifetime of the material and especially in the packaging industry, where large changes in the dimensions of a film or coating can be devastating. The tensile properties of CNF nanopaper/films and CNF-based materials in general are strongly impaired when the materials are exposed to water. Oxygen permeability is proportional to the free space volume in the material, and swelling of bio-based materials due to moisture sorption will drastically reduce the barrier film properties, which makes it challenging to use them in many everyday products such as food packages. Larsson, P. A., et al., Green Materials 2014, 2, 163-168, showed in a microscopy study that covalent crosslinking of cellulose nanofibrils can prevent the swelling and maintain the gas barrier properties in films. Shimizu, M, et al., J. Membr. Sci. 2016, 500, 1-7, used multivalent ions together with anionically charged CNF to prepare water-resistant and high oxygen-barrier nanocellulose films.

Alginate is a linear polysaccharide that is a block co-polymer of L-Guluronic acid (G) and D-Mannuronic (M) acid in three different types of blocks: GG, MM, and MG/GM. The GG block is α-1,4-linked L-Guluronic acid which forms a buckled shape that can host multivalent ions, typically Ca²⁺. Steginsky, et al., Carbohydr. Res. 1992, 225, 11-26 and Haug, et al., Acta Chem. Stand. 1966, 20, 183-190 have shown that the calcium ions crosslink alginate chains into a strong gel network. The most common source of alginate is the cell wall of brown algae. Other gelling polysaccharides are pectin, which is found in the primary cell wall of plants; carrageenan, such as ι-carrageenan and κ-carrageenan, which are found in red algae; and gellan gum which is produced by the bacterium Sphingomonas elodea. The specific gelling ions for pectin, and ι-carrageenan is Ca²⁺, and K⁺ for κ-carrageenan. The gelling of low-acyl gellan gum is promoted by calcium, magnesium, sodium, and potassium ions. Alginate and carrageenan are widely used in food industry as a thickener or gelling agent, but recently research is also focused towards biomedical applications. Markstedt, et al., Biomacromolecules 2015, 16, 1489-1496, added CNF to alginate to form a hydrogel used for 3D-bioprinting. Small amount of CNF, cellulose nanocrystals (CNC), or bacterial cellulose (BC) have been used to provide rigidity by acting as a reinforcement to alginate or carrageenan gels and films. Sirviö, et al., Food Chemistry 2014 151, 343-351, reinforced alginate based biocomposite films with up to 50 wt % cellulose fibres using a solvent casting approach. There is still a need for new bio-based materials with high wet strength, that are stable in moist or wet conditions and that do not lose the properties they have in the dry state, while at the same time maintain the biodegradability.

### SUMMARY OF THE INVENTION

It is an object of the present invention to provide a bio-based composite material with impressive toughness and hygroplastic behaviour in wet conditions as well as increased stiffness and extensibility in the wet state. It has surprisingly been found by the present inventors that small amounts of an anionic gelling polysaccharide in a CNF composite material that subsequently is dried and treated with a multivalent ion, forms a water-resistant material with impressive toughness and hygroplastic behaviour in the wet state as well as increased stiffness and extensibility in the wet state. The high CNF content also allows for a rapid and controlled process to create nanopaper films.

The composite material according to the present invention comprises 65-99 wt % cellulose nanofibers and 0.5-30 wt % of an anionic gelling polysaccharide, as calculated by dry weight of the composite material. The invention also provides a method for the preparation of such composite material, and the use of such composite material as a film, in a laminate, a 3D formed object, a packaging material, or as wet-stable filaments.

### BRIEF DESCRIPTION OF THE DRAWINGS

FIG. 1 presents the relative swelling thickness of composite materials according to the present invention and reference materials in different environments.

FIG. 2 presents wet tensile properties for different materials and composites showing: a) representative engineering strain-stress curves, b) the Young's modulus under tension vs the tensile strength, and c) the work of fracture vs strain at break.

FIG. 3 presents dry tensile properties at 50% relative humidity and 23° C. for different materials and composites showing: (a)-(c) representative engineering strain-stress curves.

FIG. 4 presents dry tensile properties at 50% relative humidity and 23° C. for different materials and composites showing: (a) the Young's modulus under tension vs the tensile strength, and (b) the work of fracture vs strain at break.

FIG. 5 presents the oxygen permeability at the relative humidities ˜50% (left) and ˜80% (right).

FIG. 6 illustrates a) the interpenetrating network formed when an object comprising CNF, an anionic gelling polysaccharide, and less than 20 wt % water (left picture) is crosslinked and soaked in water (right picture), and b) the interpenetrating network formed when an object comprising CNF and an anionic gelling polysaccharide is crosslinked in the swollen gel state (left picture) and then dried and reswollen (right picture). The stars represent crosslinking nodes.

FIG. 7 compares the wet tensile properties of a pristine CNF nanopaper and a 90:10 CNF:alginate composite material (containing 90 parts per weight of CNF to 10 parts per weight of alginate) when the dried materials are treated with Ca²⁺ or when they are treated from the swollen gel state with Ca²⁺.

FIG. 8 presents normalized FTIR spectra of CNF, alginate, and composite samples in the sodium or calcium state.

FIG. 9 presents the thickness distribution of the CNF used for the composite material.

FIG. 10 presents the wet tensile properties of 90:10 CNF:alginate composites that had been treated with different ions.

FIG. 11 presents the effect of drying and reswelling on the wet tensile properties of 90:10 CNF:alginate crosslinked with Fe³⁺ ions.

FIG. 12 presents the wet tensile properties of CNF:alginate composite materials with different CNF:alginate ratios.

FIG. 13 presents the wet tensile properties of 90:10 CNF:alginate composite materials that have been treated with Ca²⁺ ions for different time periods.

### DETAILED DESCRIPTION OF THE INVENTION

In a first aspect, the invention relates to a composite material comprising 65-99 wt % cellulose nanofibers (CNF), and 0.5-30 wt % of an anionic gelling polysaccharide, as calculated by dry weight of the composite material.

The term “CNF” is used herein for cellulose nanofibers liberated from wood pulp or from other sources, for example selected from the group consisting of plants, tunicate, and bacteria by means of mechanical disintegration, often preceded by a chemical pretreatment, such as by oxidation with 2,2,6,6-tetramethylpiperidine-1-oxyl (TEMPO) giving TEMPO-oxidized CNF, or by carboxymethylation giving carboxymethylated CNF; or by enzyme-treatment, such as by endoglucanases, giving enzymatic CNF. CNF typically have a smallest dimension in the range 2-100 nm, while the length can be several micrometers, such as up to 10 μm, and therefore the aspect ratio of CNF (ratio of length to diameter) is very large. An advantage of using CNF from wood-pulp is the abundance of wood-based cellulose and the existing, efficient infrastructure for the handling and processing of pulp and fibers. The term “anionic gelling polysaccharides” is used herein for anionic polysaccharides that can increase the viscosity of a liquid in the presence of cations. Examples of suitable anionic gelling polysaccharides are alginate, carrageenan, pectin or gellan gum; especially alginate.

The weight ratio of CNF to anionic gelling polysaccharide in the composite material according to the present invention may range from 70:30 to 99:1 parts per weight of CNF to anionic gelling polysaccharide. The composite material according to the present invention may comprise 70-99 wt %, or 70-98 wt %, cellulose nanofibers (CNF), and 1-30 wt %, or 1-29 wt %, of an anionic gelling polysaccharide, as calculated by dry weight of the composite material. The composite material may further comprise multivalent metal or metalloid ions, such as divalent or trivalent metal or metalloid ions. Examples of suitable divalent ions are selected from ions of calcium, copper, magnesium, manganese, strontium, cobalt and zinc. Examples of trivalent ions are selected from iron, aluminium, or neodymium ions. The composite material preferably comprises Ca²⁺ or Fe³⁺. Most preferably the material comprises Ca²⁺. The multivalent ions may work as crosslinks in the material by forming covalent bonds, or a mixture of ionic and dative covalent bonds. Suitable amounts of multivalent ions are from 0.0005 wt % up to 20 wt %, or from 0.5 wt % up to 10 wt %, or from 1 wt % to 10 wt %, or from 1.5 wt % up to 10 wt %, as calculated on the dry weight of the material. The composite material according to the present invention may, when dried, comprise less than 30 wt % water, less than 20 wt % water, or less than 10 wt % water, as calculated on the total weight of the composite material. Even when the composite material according to the present invention is in a wet state it may comprise less than 70 wt % water as calculated on the total weight of the composite material. The person skilled in this field understands how to estimate the amount of water in the material, for example the water content may be calculated from the difference in weight between dry material and wet material. The composite material according to the present invention may also comprise other additives, such as pigments, fillers, and nanoparticles.

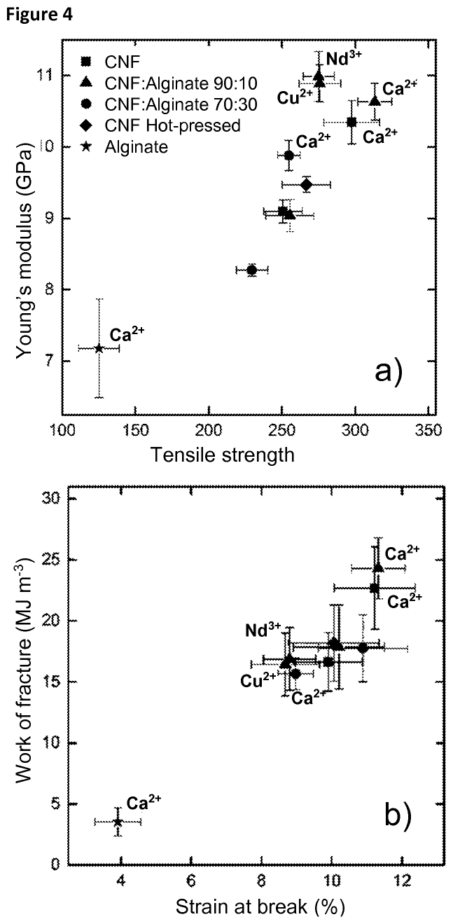

An advantage with the composite material according to the present invention is that it may comprise only bio-based materials. A further advantage with the composite material according to the present invention is that excellent tensile mechanical properties can be achieved both in wet and dry state, with as much as 99 wt %, or 95 wt % or 90 wt % CNF, and only 1 wt %, or 5 wt %, or 10 wt % of an anionic gelling polysaccharide, as calculated on the dry weight of CNF and anionic gelling polysaccharide. The composite material according to the present invention may thus comprise a ratio of 99:1, or 95:5, or 90:10 parts per weight of CNF to anionic gelling polysaccharide. A high content of CNF provides more homogeneous films. Too high concentrations of the anionic gelling polysaccharide prevent preparation of films by filtration due to too low retention of gelling polysaccharide. A combination of 70-99 wt %, or 70-95 wt % or 70-90 wt % CNF and 1-30, or 5-30 wt %, or 10-30 wt % of an anionic gelling polysaccharide, as calculated on the dry weight of CNF and anionic gelling polysaccharide, may form an interpenetrating network, wherein the gelling polysaccharide forms a fine entangled network interpenetrating a CNF-network. In such interpenetrating network, the gelling polysaccharide, for example alginate, may work as a sacrificial network that may gradually break and dissipate energy while the CNF network provide long range stress transfer. Multivalent ions may lock the interpenetrating network between the gelling polysaccharide and CNF (FIG. 6). This combination gives a very ductile material. A greater amount of the gelling polysaccharide such as more than 30 wt %, as calculated on the dry weight of CNF and anionic gelling polysaccharide before crosslinking, will impair the mechanical properties of the material, such as the tensile strength, in the wet state.

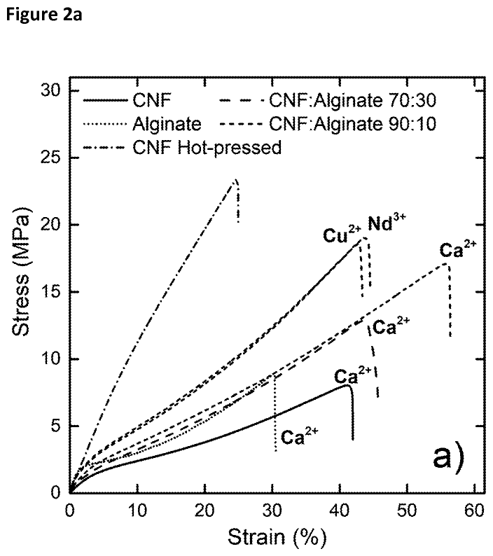

The composite material according to the present invention shows significantly better tensile mechanical properties than what would have been expected by a proportional combination of the material properties from the individual components, i.e. pristine materials of CNF and the gelling polysaccharide that each are treated with a multivalent ion or metalloid ion, such as Ca²⁺ (FIG. 2). One effect of using 1-30 wt %, 5-30 wt %, or 10-30 wt % of an anionic gelling polysaccharide with 70-99 wt %, 70-95 wt %, or 70-90 wt % CNF, as calculated on the dry weight of CNF and anionic gelling polysaccharide, and crosslinking such composition with a multivalent ion or a metalloid ion is that both the Young's modulus under tension and the tensile strength are extensively increased in the wet state, often more than doubled compared to individual CNF or anionic gelling polysaccharide materials. Unless otherwise specified all tests disclosed herein are performed at 1 atm and 23° C. “Wet state” as used herein is defined as soaking the composite material in an aqueous solution for example for at least 1 minute, at least 10 minutes, at least 1 hour, at least 6 hours, at least 12 hours, or at least 24 hours. When determining the mechanical properties in the wet state, the composite material is soaked in MilliQ-water for 24 hours prior to tensile testing, to estimate the mechanical properties in the wet state. The mechanical properties in the wet state of the composite material according to the present invention may be comparable to a stiff and though rubber, but without elastic recovery which makes the material exceptional for hygroplastic forming, for example by vacuum forming, blow moulding or pressing, into three dimensional (3D) shapes. The term “hygroplastic” is used herein for plastic deformation due to plasticization by water. A tension stress-strain curve for the present composite material may show three different regions: a short elastic region, a plastic region, and strain induced stiffening. In the wet state the composite material disclosed herein may resist a strain before failure, i.e. strain at break, of at least 40%, or at least 50%. The composite material may further have a work of fracture of at least 3 MJm⁻³, or at least 5 MJm⁻³, in the wet state. Work of fracture (γ_{wof}) as used herein is obtained by determining the energy at break (J), as the area under the tensile curve (can be determined by Bluehill® software by Instron®), normalized by the dimensions of the tested sample (m³). The composite material according to the present invention may have a tensile strength of at least 10 MPa, at least 12 MPa, or at least 15 MPa in wet state, i.e. when the material has been soaked in water, such as in MilliQ-water, for at least 24 hours. The composite material according to the present invention may have a Young's modulus under tension of at least 75 MPa, at least 100 MPa, at least 125 MPa, at least 200 MPa, when soaked in water, such as MilliQ-water, for at least 24 hours. Using Ca²⁺ in the composite material according to the present invention provides the composite material in wet conditions with improved tensile properties, e.g. improved hygroplastic properties, for example a strain at break of at least 50%. Using Fe³⁺ in the composite material according to the present invention provides the composite material in wet conditions with improved stiffness, e.g. higher Young's modulus, such as a Young's modulus under tension of at least 850 MPa, or at least 900 MPa, or at least 1000 MPa.

The composite material according to the present invention may have a tensile strength of at least 250 MPa, or at least 300 MPa, and a Young's modulus under tension of at least 9.0 GPa, at least 9.5 GPa at least 10 GPa, or at least 10.5 GPa, in the dry state. “Dry state” as used herein is defined as drying the material followed by conditioning at 50% RH and 23° C. for at least 24 hours prior to tensile testing, unless otherwise specified. The yield point of a composite material according to the present invention may be at least 100 MPa in the dry state. Copper is the divalent ion with one of the highest affinities towards alginate and can interact with all the blocks in the alginate co-polymer.

Neodymium ions have also shown interactions with alginate to form layered structures with high dry strength. Use of Nd²⁺ and Cu²⁺ in the composite material according to the present invention provides a stiffer but more brittle material in the dry state compared to the use of Ca²⁺. The yield point of a composite material according to the present invention may be at least 100 MPa, at least 125 MPa, or at least 150 MPa in the dry state. A composite material according to the present invention may resist a strain of at least 8%, at least 9%, at least 10%, or at least 11%, before failure in the dry state, and may further have a work of fracture of at least 17 MJm⁻³, or at least 20 MJm³, or at least 24 MJm⁻³, in the dry state. The divalent ion is preferably calcium due to the higher toughness and higher strain at break.

The composite material disclosed herein may be in the form of a film or a nanopaper and may have a thickness of 1-1000 μm, 1-500 μm, 5-200 μm, 30-100 μm, 40-70 μm, or of 50-60 μm, when dried and conditioned at 50% RH and 23° C. Water may act as a plasticizer for the composite material according to the present invention and may provide the material with hygroplastic properties that can allow similar processing routes as those used for thermoplastic polymers. When soaked in water the composite material may extend more than 50% of its original dimensions without elastic recovery after deformation and can hence be pressed into three dimensional (3D) objects. The material can then be dried into a stiff and tough 3D-nanopaper structure. When the composite material according to the present invention is in the form of a film or nanopaper it may have a unidirectional swelling in the thickness direction. An unexpected effect of using an anionic gelling polysaccharide, especially alginate, and multivalent ions in the composite material according to the present invention is that they may lock the CNF network and make it more stable in a wet state. This provides for a reduced swelling when the composite material is soaked in water. The relative swelling thickness, Ad, is measured by soaking the composite material in an aqueous solution for 24 hours and measuring the thickness (d) of the film before and after soaking. The relative swelling thickness of the nanopaper or film is calculated using the equation (1):

$$Δ d = \frac{{d}_{w e t} - {d}_{d r y}}{{d}_{d r y}} \qquad ( 1 )$$

wherein d_{dry} is the thickness of the dried material before soaking, and d_{wet} is the thickness of the material after soaking. The relative swelling thickness, Ad, of a composite material according to the present invention comprising 65-99 wt % CNF and 0.5-30 wt % of anionic gelling polysaccharide, as calculated on the dry weight of the composite material, that has been soaked in an aqueous solution for 24 hours may be at most 2.5, or at most 3.5. The composite material according to the presented invention may have a thickness of 1-3500 μm, 10-3500 μm, 40-3500 μm, 1-1000 μm, 10-1000 μm, 40-1000 μm, 1-200 μm, 10-200 μm, 40-200 μm, or 80-150 μm, when soaked in water, such as in MilliQ-water.

The gas barrier properties of these films also add value in terms of packaging. A composite material according to the present invention may be used as a gas barrier. At 50% RH and 23° C., the composite material according to the present invention may have an oxygen permeability that is lower than 0.5 cm³·μm·m⁻²·day⁻¹·kPa⁻¹. Oxygen permeability is obtained as the arithmetic product of the measured oxygen transmission rate and the thickness of the measured film. An advantage with the composite according to the present invention is that the oxygen barrier is considerably improved at a high relative humidity, e.g. at 80% relative humidity, compared to corresponding material prepared from CNF without anionic gelling polysaccharide, as well as from calcium treated CNF. The composite material according to the present invention may have an oxygen permeability that is lower than 10 cm³·μm·m⁻²·day⁻¹·kPa⁻¹, or lower than 8 cm³·μm·m⁻²·day⁻¹·kPa⁻¹, or lower than 7 cm³·μm·m⁻²·day⁻¹·kPa⁻¹ at 80% RH and 23° C. Such gas barrier properties of the composite material may be useful in packaging of oxygen sensitive material, for example food.

In a further aspect, the present invention relates to a method for the preparation of a composite material according to the present invention, wherein the method comprises the steps of:
a) mixing a CNF suspension with an anionic gelling polysaccharide to obtain a dispersion with 70-99 wt % of CNF and 1-30 wt % of an anionic gelling polysaccharide, as calculated on dry weight of the dispersion;
b) removing the dispersing medium wherein the CNF and the gelling polysaccharide are dispersed to obtain an object comprising CNF and the anionic gelling polysaccharide and less than 20 wt % water, as calculated on the total weight of the obtained object;
c) soaking the object obtained in step b) in a solution comprising multivalent metal or metalloid ions to obtain the composite material in a soaked state.

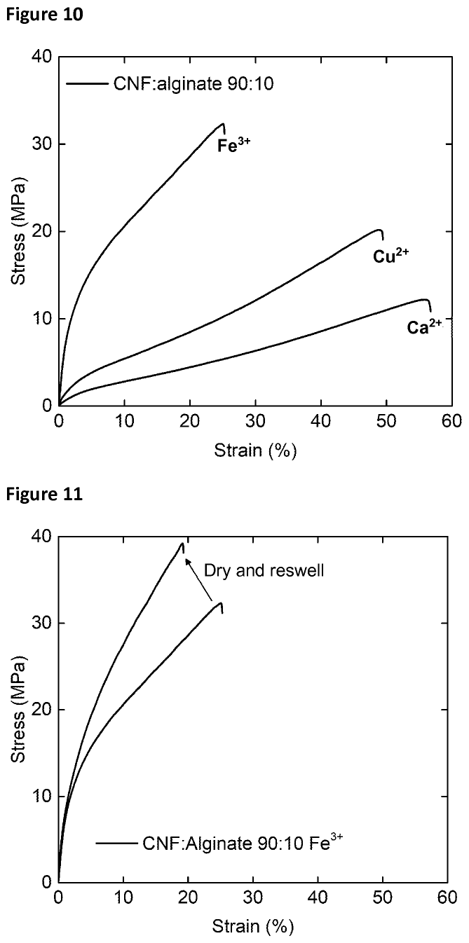

Soaking in step (c) may include dipping the object obtained in step (b) in solution comprising multivalent metal or metalloid ions, or preferably soaking the material in solution comprising multivalent metal or metalloid ions for at least 1 minute, at least 10 minutes, at least 1 hour, at least 6 hours, at least 12 hours, or at least 24 hours. The solution comprising multivalent metal or metalloid ions may be an aqueous solution and may have a concentration of at least 0.5 wt %, or at least 1 wt %, of a salt of the multivalent metal or metalloid ion. The concentration of the salt of the multivalent metal or metalloid ion in the aqueous solution used for soaking the object in step (c) may be at most 40 wt %, or at most 20 wt %. The composite may be rinsed, e.g. in MilliQ water, after step c) to remove excess metal ions. The method may further comprise a step d) where the composite material obtained in c) is formed into a desired shape. Forming may be made by conventional methods for forming a plastic material, such as thermoforming methods or blow moulding, for example by vacuum forming or pressing. The method may also comprise an additional step e) where the composite material in step c) or d) is dried to obtain an object comprising less than 20 wt % water, or less than 10 wt % water, as calculated on the total weight of the composite material. The dried object is stable in water. Repeated cycles of drying the composite material followed by soaking it in an aqueous solution, after the treatment with multivalent ions, may provide even better mechanical properties in the wet state (FIG. 11).

The concentration of CNF in the CNF suspension to be mixed in step (a) may be at least 0.05 wt %, at least 0.1 wt %, at least 0.2 wt %, or at least 0.5 wt %, calculated on the total weight of said suspension. CNF suspensions comprising up to and including 6 wt %, up to and including 5 wt %, up to and including 3 wt %, or up to and including 1 wt % CNF, calculated on the total weight of the CNF suspension, may also be used in step (a). The anionic gelling polysaccharide to be mixed in step (a) may be in a solution or suspension, for example dissolved in an aqueous solution, or it can be added in solid form to the CNF suspension. When the gelling polysaccharide is in a solution or suspension it may be in a concentration of at least 0.001 wt %, at least 0.01 wt %, or at least 0.05 wt %, as calculated on the total weight of said solution or suspension. A solution or suspension of an anionic gelling polysaccharide with up to and including 3 wt %, or up to and including 2 wt %, or up to and including 1 wt % of the anionic gelling polysaccharide, as calculated on the total weight of said solution or suspension, may also be used in step (a). Examples of suitable anionic gelling polysaccharides are alginate, carrageenans, pectin or gellan gum. Especially alginate is a suitable anionic gelling polysaccharide.

The CNF and anionic gelling polysaccharide in step (a) are preferably dispersed in an aqueous solvent, such as water. The dispersing medium may comprise a salt of a monovalent ion, such as sodium chloride. The dispersion of CNF and an anionic gelling polysaccharide obtained in step (a) may have a total solid content of from 0.1 wt %, or from 0.15 wt % or from 0.25 wt %, up to and including 5 wt %, or up to and including 3 wt %, or up to and including 2 wt %, as calculated on the total weight of the dispersion.

In step b) the dispersing medium, e.g. water, may be removed by conventional methods, preferably by filtering, such as vacuum filtering, or drying in an elevated temperature, or more preferably a combination of these, such as filtering followed by drying. If the liquid is removed by filtering a filter cake may be obtained. The filter cake may be further dried in an elevated temperature or at reduced pressure, or in a combination thereof. The removing of dispersing medium in step b) may be performed until the moisture content of the obtained object is below 20 wt % as calculated on the total weight of the obtained object, or preferably below 10 wt %, or more preferably below 5 wt %. Soaking in step (c) of the object obtained in step (b), may provide crosslinks comprising the multivalent ions. The crosslinks may be in the form of covalent bonds, or a mixture of ionic and dative covalent bonds, and may lock the CNF networks in a compact state (FIG. 6a). The object obtained in step b) with the method according to the present invention may be in the form of a slab, a film, a nanopaper, or in the form of filaments. The term “filament” is used herein for a long continuous length of the composite material, for example in the form of a thread or yarn. The length of the filament is in principle only limited by the amount of the composite material available. Filaments of the composite material can be obtained by injection or extrusion of the dispersion obtained in step a) into a salt or acidic aqueous solution to form a gel filament, followed by removal of the dispersing medium and said salt or aqueous solution according to step b), such as by filtering, or drying in an elevated temperature, or a combination of these, such as filtering followed by drying. The obtained filament is then treated with multivalent metal or metalloid ions according to step c).

The state in which the networks are formed by the introduction of counter-ions is vital. When multivalent metal ions are introduced to a swelled never-dried composite film, the swollen state will form a network with a lot of voids between physically locked fibrils. In this case, the network of anionic gelling polysaccharide will be adapted to the swollen state of the CNF and when the CNF network is drying the anionic gelling polysaccharide will collapse (FIG. 6b) and the collapsed network of the anionic gelling polysaccharide will only have a little influence on the properties of the material in the wet state. When an object comprising CNF, an anionic gelling polysaccharide, and less than 20 wt % water is crosslinked, as in the method of the present invention, the network of CNF will not be swollen and thus the anionic gelling polysaccharide will adapt to the CNF network and be crosslinked in a compact state and thus provide a tough material in water (FIG. 6a). This material will also show a reduced relative swelling thickness compared to a material that has been crosslinked in the swollen state.

Colloidal dispersions of CNF have a low overlap concentration due to the high aspect ratio of the fibrils, and is therefore extra sensitive to increased ion concentration, pH, and the addition of charged or interacting uncharged polymers, which makes it difficult to mix CNF with other components without causing flocculation or gelation. The anionic nature of both the gelling polysaccharide and nanocellulose facilitates a homogenous mixing which is almost impossible to achieve with oppositely charged or uncharged systems. Exposing the homogenous composite material to different multivalent ions, for example Ca²⁺, Cu²⁺, Mg²⁺, Mn²⁺, Sr²⁺, Co²⁺, Zn²⁺, Al³⁺, Fe³⁺, or Nd³⁺, locks the different networks into a material that shows synergetic effects. In the method according to the present invention, the solution in step c) thus may comprise divalent ions, such as Ca²⁺, Cu²⁺, Mg²⁺, Mn²⁺, Sr²⁺, Co²⁺, Zn²⁺, or trivalent ions, such as Al³⁺, Fe³⁺Nd³⁺. Preferably the solution in step c) comprises Ca²⁺ or Fe³⁺. Most preferably the solution in step c) comprises Ca²⁺.

In an additional aspect, the present invention relates to the use of the composite material according to the present invention as a nanopaper. The material is hygroplastic and when the composite is in a wet state, i.e. soaked in water or an aqueous solution, it may be pressed into 3D objects. By subsequent drying the material will become a stiff and tough 3D-nanopaper structure. Such material can replace thermoplastic materials, for example in food packaging. The composite material may also be used in a laminate, a packaging material, in 3D object, or as filaments.

Experimental

Characterization

Relative Swelling Thickness

Samples of films were left to swell in Milli-Q, or 1 wt % salt solution for 24 hours and the thickness (d) was measured after the surfaces were dabbed with fine paper to remove excess water. It was observed that the composite films had a unidirectional swelling in the thickness direction and the thickness was used as an easy way to study the wet-integrity. The relative swelling thickness was calculated using the equation:

$$Δ d = \frac{{d}_{w e t} - {d}_{d r y}}{{d}_{d r y}} \qquad ( 1 )$$

wherein d_{dry} is the thickness of the dried material before soaking, and d_{wet} is the thickness of the material after soaking.

Tensile Testing

Samples of films were cut into pieces of 50×3 mm by reinforced Razor blade cutting (reinforced, No. 743, VWR). The samples were clamped with a gauge length of 20 mm in an intron 5944 with a 500N load cell and were tested at a strain rate of 2 mm/min. The Young's modulus under tension was calculated as the slope of the curve between the strain of 0 and 0.3%. When measuring the tensile properties in the wet state, the wet samples had a small linear region between 0-0.15% and the slope of this region was used to calculate the Young's modulus under tension. 7-10 samples for each composite were tested and the average modulus, strain at break, tensile strength, and work of fracture were presented as 95% confidence intervals using a student's t-test. The dry tensile properties of the materials were performed on films that had been dried and conditioned at 50% RH and 23° C. for 24 hours prior to testing. The drying of the films was performed using a Rapid Köthen. The wet tensile properties of the materials were performed on films that had been soaked in Milli-Q water for 24 h prior to testing.

Oxygen Permeability

The oxygen permeability was measured for a sample area of 5 cm² using a MOCON (Minneapolis, Minn., USA) OX-TRAN 2/21 (ISO 9001:2015). The measurements were performed symmetrically with the same relative humidity on both sides of the sample at 23° C. and the relative humidity of 51-52% or 82-83%. Two measurements were conducted on each composite sample.

### Example 1

### Comparison of Materials Prepared from Different Compositions Materials

CNF Preparation

A 2 wt % CNF gel was kindly provided by RISE bioeconomy (former Innventia), Stockholm, Sweden. The CNF was derived from a dissolving grade pulp that had been carboxymethylated to a charge density between 500-600 μmol/g prior to the defibrillation. The gel was further homogenised using a microfluidizer by three passes through a serial 200-100 chamber configuration, diluted to a dry content of 0.2 wt % at a volume of 900 mL, and dispersed using ultra-turrax at 13000 rpm for 20 minutes. The gel was centrifuged at 4100×g for 1 h to remove larger aggregates or flocs.

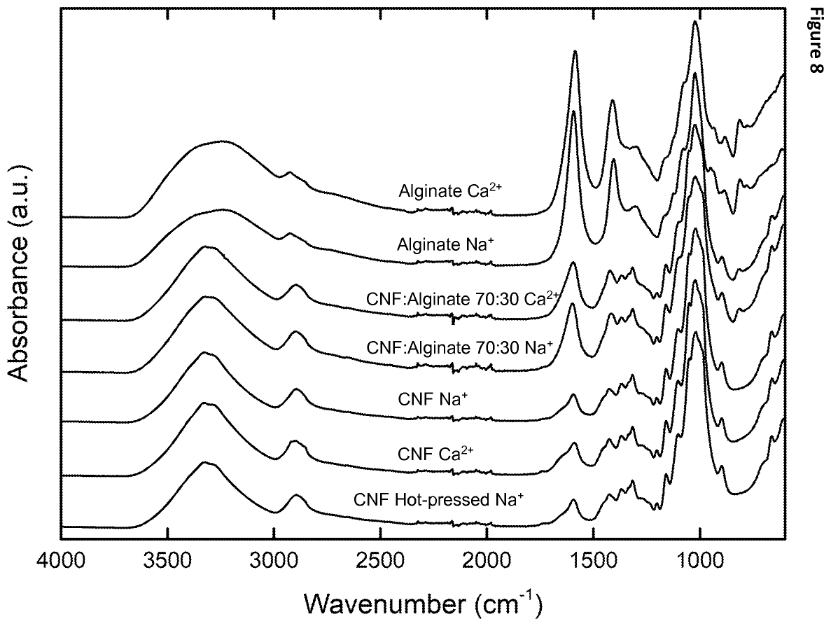

The dimensions of the fibrils were determined with atomic force microscopy (AFM) by adsorbing CNF for 1 min from a 0.001 wt % dispersion onto plasma treated silicon wafers (boron-doped, p-type, 610-640 μm) already covered with a polyvinyl amine anchoring-layer (Lupamin 9095, BASF) that was adsorbed from a 0.1 g/L solution at pH 7.5 for 2 minutes. Images, 1×1 μm in size, was acquired at random positions on the prepared wafer using a MultiMode 8 AFM (Bruker, Santa Barbara, Calif., USA) in the ScanAsyst mode. The height of 250 fibrils was measured and the thickness distribution is shown in FIG. 9.

Algae Polysaccharides Preparation

A solution of alginic acid sodium salt from giant brown algae (high viscosity, Alfa Aesar) was prepared by overnight dissolution during mild stirring at a concentration of 0.25 wt % the alginic salt in water. The alginate contained an insoluble fraction of approximately 15 wt % that was removed by filtration through a 5μm syringe-filter (Acrodisc, Supor membrane, Pall) and no aggregates were observed by microscope after the filtration.

The G and M ratio of the alginate was estimated by a method described by Grasdalen et al. in Carbohydr. Res. 1979, 68, 23-31 where the ¹H-NMR spectra was used to compare 3 different chemical shifts corresponding to G, M and GG. The alginate was hydrolysed at pH 3 and 100° C. for 1 h, neutralized, and dried at room temperature. The alginate hydrolysate was dissolved in deuterated water at a dry content of 2 wt % for the ¹H-NMR analysis at 500 MHz on a Bruker DMX-500 NMR spectrometer. This approach resulted in an estimated G content of 41% and M content of 59% distributed into the blocks of 27% GG, 28% MG, and 45% MM.

Kappa (κ) carrageenan (Sigma Aldrich) and iota (ι) carrageenan (Sigma Aldrich) was used as received and was dissolved over night at a concentration of 0.2 wt %. The composition was confirmed using ¹H-NMR at ambient temperature in which κ-carrageenan has a signature shift at 5.01 ppm and ι-carrageenan has a signature shift at 5.20 ppm. The ι-carrageenan also had a peak at 5.32 which might be λ-carrageenan or contamination from floridean starch (van de Velde, F. et al., in Modern Magnetic Resonance, Webb, G. A., Ed.; Springer Netherlands: Dordrecht, 2006, pp 1605-1610). Sharp NMR-shifts indicating oligomeric or monomeric fractions were also observed and could be removed by dialysis. The integral comparison of the peaks showed that the ι-carrageenan contained 22% κ-carrageenan and 12% contamination, while the κ-carrageenan contained 12% ι-carrageenan. The molecular weight for ι-carrageenan was given by the supplier with Mn between 193 and 324 kDa, and Mw between 453 and 652 kDa. The molecular weights of the alginate and carrageenan were characterized by size exclusion chromatography in a Dionex Ultimate-3000 HPLC system (Dionex, Sunnyvale, Calif., USA) with a series of three PSS suprema columns in the pore size configuration 30 Å, 1000 Å, and 1000Å, maintained at 40° C. with a mobile phase of 10 mM NaOH (1 ml/min). The relative molecular weight was determined using a pullulan standard with a range of 342 to 708,000 Da (PSS, Germany) and the results are given in Table 1.

TABLE 1

| Sample | Relative M_{w} (kDa) | Relative Mₙ (kDa) | PDI |
|---|---|---|---|
| Alginate | 1209 | 645 | 1.88 |
| κ-carrageenan | 1193 | 733 | 1.63 |
| ι-carrageenan | 995 | 417 | 2.39 |

It should be noted that all samples are on the limit of both the column and the pullulan standard and should be considered more as a comparison and an indication of the dispersity rather than exact values. Additionally, the polyelectrolyte effect of these polysaccharides makes them appear larger in SEC and it is important that the molecular weight is considered as a relative value to pullulan only.

Preparation of CNF/Alginate Metalloid Ion Composite Films

A 0.2 wt % dispersion CNF was mixed with a ˜0.2 wt % alginate solution at various CNF:alginate ratios (90:10 and 70:30). Each sample was mixed to a volume of 200 mL and about 0.2 wt % total solid content, using the ultra-turrax for 9 min at 9000 rpm which was enough to avoid formation of large amounts of bubbles. The dispersion (400 mg dry weight) was filtered through a Durapore Membrane Filter (PVDF, Hydrophilic, 0.65 μm) in a Kontes microfiltration assembly with a filter diameter of 8 cm. The filtration time varied between 9-36 h depending on the fraction of algae polysaccharide. The retention was determined by measuring the dry content of the filtrate and was above 90% for the alginate. The 1-2 mm wet gel that was formed after the filtration was dried for 20 min at 92° C. and at a reduced pressure of 95 kPa using the drying section of a Rapid Köthen sheet former (Paper Testing Instruments, Austria). The dried films were 50-60 μm thick. The dried films were then soaked in either 1 wt % CaCl₂ (>97%, Sigma Aldrich), 1 wt % KCI (>99%, Sigma Aldrich), 1 wt % Cu(NO₃)₂ (>99%, Sigma Aldrich) or 1 wt % NdCl₃ (>99%,Sigma Aldrich) solutions for 24 hours in order to crosslink the composite material. Thereafter the composite films were rinsed in Milli-Q water for 24 hours.

Preparation of CNF/Carrageenan Metalloid Ion Composite Films

The same procedure as the described above was used in order to prepare composite films comprising CNF and either ι-carrageenan or κ-carrageenan. The CNF:algae ratio was in both cases 70:30. Dried films were obtained by filtrating the wet gel (retention above 80% for ι-carrageenan, and above 70% for κ-carrageenan) through a Durapore Membrane Filter (PVDF, Hydrophilic, 0.65 μm) in a Kontes microfiltration assembly with a filter diameter of 8 cm and thereafter drying the wet gel 20 min at 92° C. and at a reduced pressure of 95 kPa using the drying section of a Rapid Köthen sheet former.

Some dried films prepared this way were used as references in the dry tensile testing and other films were further soaked in either 1 wt % CaCl₂ or 1 wt % KCI for 24 hours and then rinsed in Milli-Q water for 24 h in order to crosslink the composite material.

Preparation of Reference Materials

Pristine CNF Films

Pristine CNF films were prepared by filtrating a 0.2 wt % CNF dispersion (400 mg dry weight) through a Durapore Membrane Filter (PVDF, Hydrophilic, 0.65 μm) in a Kontes microfiltration assembly with a filter diameter of 8 cm. The wet gel that was formed after the filtration was dried for 20 min at 92° C. and at a reduced pressure of 95 kPa using the drying section of a Rapid Köthen sheet former. The dried films were in the same thickness range as the CNF:alginate composite films.

Some pristine CNF films were used as described below as reference samples in the dry tensile tests. Other samples were further soaked in 1 wt % CaCl₂ for 24 h and then rinsed in Milli-Q water for 24 h. Those samples have a reference name such as CNF Ca²⁺.

Pristine CNF hot-pressed nanopapers were prepared by hot-pressing the pristine CNF film, prepared according to the above method, at 150° C. for 1 h at a pressure of 20 kN. The nanopaper turned yellow-orange, and this sample was used as a reference of a covalent crosslinked network.

Pristine Alginate Film

The pristine alginate film (400 mg dry weight) was solvent-cast under ventilation at ambient temperature over a period of 7-10 days starting with a 0.4 wt % alginate solution. The alginate solution was prepared (and filtrated) in the same way as described in the method section of Example 1 but reaching a final solid content of 0.4 wt %.

Results

Swelling Thickness

Films of composite materials containing either only CNF, only alginate, or CNF and 10 or 30 wt % algae polysaccharides were prepared as described above and crosslinked with either calcium and potassium ions. The unidirectional swelling of these films made it possible to use the thickness as a qualitative measurement of the wet-integrity as compared to the change in mass. The equilibrium swelling pressure (Π) of a polyelectrolyte gel can be divided into three contributing parts according to:

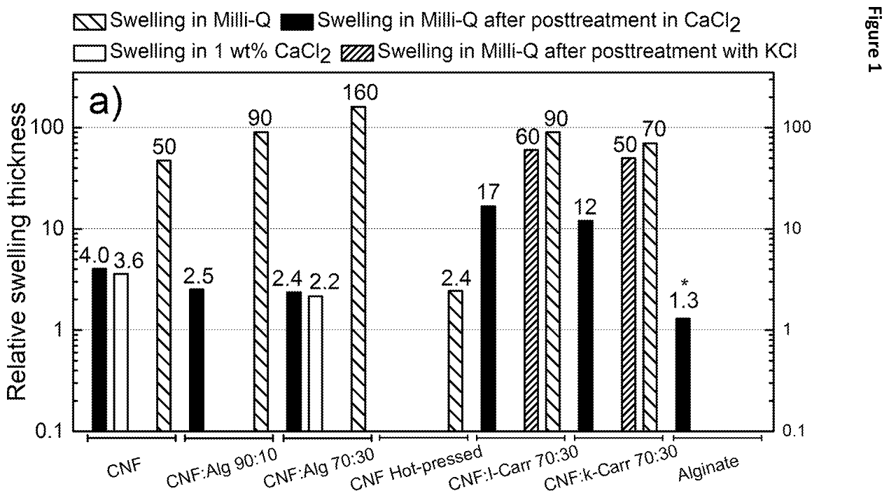

Πₘᵢₓ+Πₙₑₜ+Πᵢₒₙ=0 (2)

where the Πₘᵢₓ is the entropy and enthalpy of mixing water and the constituents of the network, Πₙₑₜ is the deformation of the network that is working against the swelling force, and Πᵢₒₙ is the osmotic pressure due to the counterions of the polyions that form the gel. At equilibrium Π is zero, which means that if Πₙₑₜ is zero the gel is dissolved and if it is high it might suppress the other contributions so that almost no swelling occurs. The relative swelling thickness of composite materials treated with different ions is shown in FIG. 1, wherein the legend for the bars are: CNF=CNF pristine film material; CNF:Alg 90:10=90 wt % CNF and 10 wt % alginate, as calculated by dry weight of CNF and alginate before posttreatment with ions; CNF:Alg 70:30=70 wt % CNF and 30 wt % alginate, as calculated by the dry weight of CNF and alginate before posttreatment with ions; CNF Hot-pressed=hot-pressed CNF material; CNF:l-Carr 70:30=70 wt % CNF and 30 wt % ι-carrageenan, as calculated by dry weight of CNF and alginate before posttreatment with ions; CNF:k-Carr 70:30=70 wt % CNF and 30 wt % κ-carrageenan, on the dry weight of CNF and alginate before posttreatment with ions; and Alginate=alginate material. The dry CNF reference nanopaper increased approximately 50 times in thickness when equilibrated in Milli-Q water. When the CNF nanopaper was treated with Ca²⁺ ions almost the entire swelling was prevented. The amount of added alginate affected the swelling thickness proportionally to the increase charge in the film in accordance with the osmotic pressure theory:

Πᵢₒₙ=Πₒₛₘ=kTΣ(C_{gel}−C₀)ᵢ (3)

where (C_{gel}−C₀)ᵢ is the concentration of ion i in the gel relative the surrounding solution. Crosslinking with calcium ions resulted in a suppression of most of the swelling and to a higher degree for the CNF:alginate composite than for the CNF reference, which means that a stronger network (Πₙₑₜ) is formed. Rinsing to remove excess salt only lead to a small increase in thickness. As a comparison to a covalent crosslinking, pristine nanopapers were hot-pressed at 150° C. for 1 hour which resulted in a yellow colour and a similar swelling, and thus wet-integrity, as the Ca²+-treated CNF:alginate composite without heat treatment. The carrageenan composites without ion-coordination had lower swelling than the same composition of CNF and alginate. The CNF:carrageenan composite nanopapers were crosslinked with both calcium and potassium ions because κ-carrageenan form the strongest gels with potassium ions and ι-carrageenan with calcium ions. CNF:Carrageenan composites were more swollen than the reference CNF treated with calcium ions. A pristine alginate film swelled 0.6 times the dry thickness. It should however be noted that this swelling is not unidirectional as for the CNF films which is indicated by the asterisk in FIG. 1.

Fourier Transform Infrared Spectroscopy (FTIR)

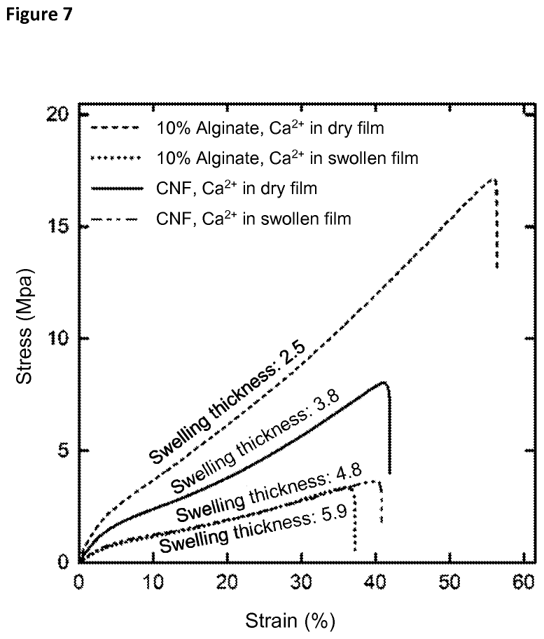

The dried films were further characterized using FTIR with an ATR add-on (PerkinElmer Spectrum 2000). The normalized FTIR-spectra are presented in FIG. 8. Na⁺ occurred in the polysaccharide materials as provided from the vendors and denotes that the material has not been soaked in a solution with multivalent ions. The legend for the FTIR-curves are CNF Hot-pressed Na⁺=hot-pressed CNF material; CNF Na⁺=CNF material; CNF Ca²⁺=CNF material soaked in CaCl₂; CNF:Alg 70:30 Na⁺=70 wt % CNF and 30 wt % alginate; CNF:Alg 70:30 Ca²⁺=70 wt % CNF and 30 wt % alginate soaked in CaCl₂; Alginate Na⁺=alginate material; and Alginate Ca²⁺=alginate material soaked in CaCl₂.

Mechanical Properties in the Wet State

A relative swelling thickness of 6-7 was close to the limit of what was feasible for tensile testing because highly swelling samples were too weak to maintain its structure in the clamped areas, and hence only the CNF hot-pressed reference, the calcium ion treated CNF and alginate references and the CNF:alginate composites crosslinked with Ca²⁺, Cu²⁺ or Nd³⁺ were possible to be evaluated in the wet state. All the samples were prepared as described in the materials section (Example 1). For this specific wet mechanical test, the samples were measured after the 24 hours rinsing step in milli-Q water described in the procedures. In the case of the CNF hot-pressed sample, the nanopaper obtained from the described procedure was soaked for 24 hours in milli-Q water prior to the wet tensile test. The results are presented in FIG. 2 and Table 2. The notations close to the curves indicate the crosslinking ion. The error bars are 95% confidence intervals.

TABLE 2

| | Young's | Tensile | Strain at | Work of |
|---|---|---|---|---|
| | modulus | strength | break | fracture |
| Sample (wet state) | (MPa) | (MPa) | (%) | (MJm⁻³) |
| Alginate Ca²⁺ | 182 ± 17 | 8.9 ± 1.6 | 32 ± 4 | 1.5 ± 0.3 |
| CNF Ca²⁺ | 62 ± 5 | 8.0 ± 0.5 | 40 ± 2 | 1.8 ± 0.2 |
| CNF hot-pressed | 184 ± 6 | 23 ± 1 | 25 ± 2 | 3.2 ± 0.4 |
| CNF:Alginate 90:10 Ca²⁺ | 135 ± 5 | 17 ± 1 | 56 ± 2 | 5.0 ± 0.4 |
| CNF:Alginate 90:10 Cu²⁺ | 223 ± 7 | 18 ± 2 | 42 ± 4 | 4.0 ± 0.7 |
| CNF:Alginate 90:10 Nd³⁺ | 248 ± 14 | 19 ± 1 | 44 ± 2 | 4.1 ± 0.3 |
| CNF:Alginate 70:30 Ca²⁺ | 125 ± 4 | 13 ± 1 | 45 ± 2 | 3.1 ± 0.3 |

Alginate Ca²⁺ = alginate material treated with calcium chloride; CNF Ca²⁺ = CNF material treated with calcium chloride; CNF Hot-pressed = hot-pressed CNF material; CNF:Alg 90:10 Ca²⁺ = 90 wt % CNF and 10 wt % alginate treated with CaCl₂; CNF:Alg 90:10 Cu²⁺ = 90 wt % CNF and 10 wt % alginate treated with Cu(NO₃)₂; CNF:Alg 90:10 Nd³⁺ = 90 wt % CNF and 10 wt % alginate treated with NdCl₃; and CNF:Alg 70:30 Ca²⁺ = 70 wt % CNF and 30 wt % alginate treated with CaCl₂.

FIG. 2 and Table 2 shows that the calcium-treated CNF pristine nanopaper (CNF Ca²⁺) had a significant wet strength with great extension before failure, but was not as stiff as the calcium-treated pristine alginate film. The combination of CNF and alginate in a composite material showed significantly better wet strength properties than would have been expected for a proportional combination of the material properties of the individual components. This indicates that CNF and alginate form synergetic interpenetrating networks. CNF Ca²⁺ presents a Young modulus ˜62 MPa and a tensile strength ˜8 MPa. When CNF was mixed with just 10 wt % alginate and the 90:10 CNF:alginate was crosslinked with calcium ions, both the modulus and the tensile strength were more than doubled and the material was able to resist a strain above 50% before failure and a work of fracture close to 5 MJ m⁻³ (FIG. 2a-c), which is comparable to a stiff and tough rubber. This data suggests that small amounts of alginate can form a fine network between CNF to transfer loads over a greater distance. When CNF was mixed with a larger amount of alginate, such as 30 wt % and crosslinked with calcium ions (CNF:alginate 70:30 Ca²+), the material presented a lower Young modulus, tensile strength and strain at break than the composite with only 10 wt % alginate. This could be due to that a larger amount of alginate (30 wt %) may disrupt the CNF network to some degree and make the material more brittle and less stiff; however it still showed a synergy effect and presented much better properties than what would have been expected for a proportional combination of the material properties of the individual components.

Copper and neodymium ions were also tested as the crosslinking agent for the 90:10 CNF:alginate composite films to investigate if the wet strength could be further improved. The results showed a significant stiffening at the cost of a deterioration in the strain-at-break.

Mechanical Properties in the Dry State

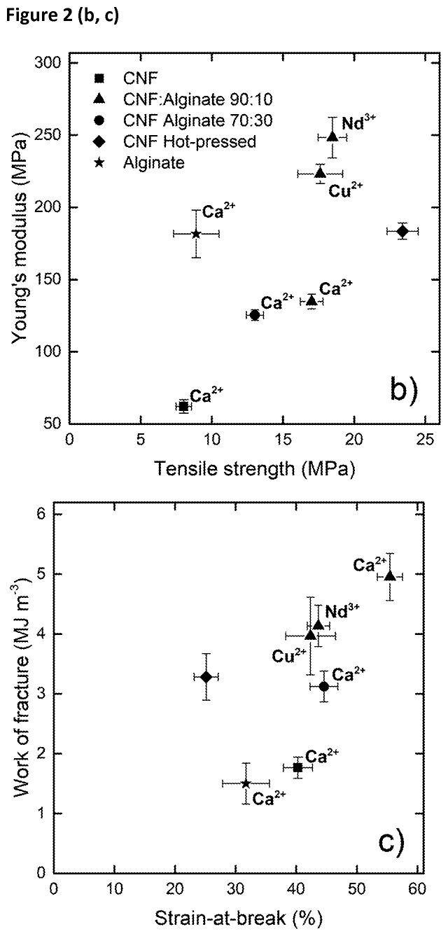

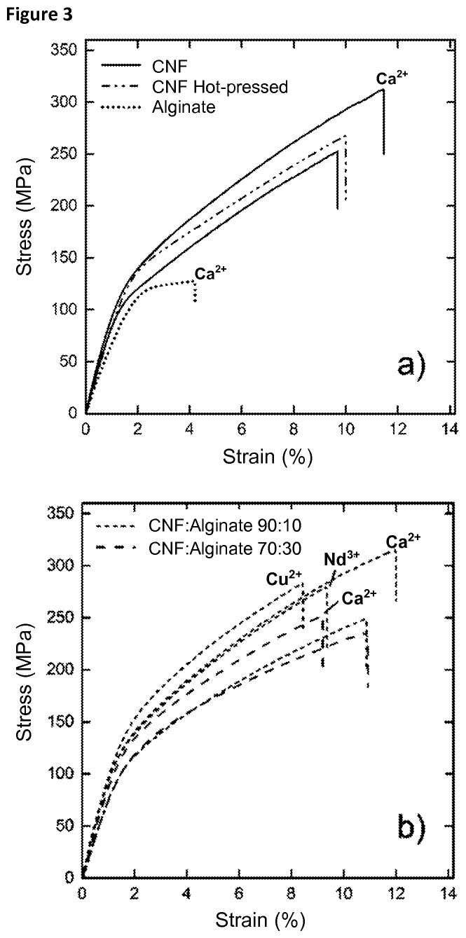

The mechanical properties of the references and composite materials were also tested in the dry state, i.e. at 50% relative humidity and 23° C., to ensure that the increased wet stability was not achieved at the cost of dry strength. All the samples were prepared as described in the materials section (Example 1). The composite films that were crosslinked with different ions and rinsed in milli-Q water were further dried using a Rapid Köthen in order to dry the samples for the tensile testing in dry state. The Young's modulus under tension, tensile strength, strain at break and work of fracture of the films in the dry state are presented in FIGS. 3 and 4, and Table 3.

TABLE 3

| | Young's | Tensile | Strain at | Work of |
|---|---|---|---|---|
| | modulus | strength | break | fracture |
| Sample (dry state) | (GPa) | (Mpa) | (%) | (MJm⁻³) |
| Alginate Ca²⁺ | 7.2 ± 0.7 | 125 ± 14 | 3.9 ± 0.7 | 3.5 ± 1.0 |
| CNF | 9.1 ± 0.2 | 251 ± 13 | 9.9 ± 1.0 | 17 ± 2 |
| CNF hot-pressed | 9.5 ± 0.1 | 267 ± 17 | 10.1 ± 1.0 | 18 ± 3 |
| CNF Ca²⁺ | 10.3 ± 0.3 | 298 ± 19 | 11.2 ± 1.2 | 23 ± 3 |
| CNF:Alginate 90:10 Ca²⁺ | 10.6 ± 0.3 | 313 ± 12 | 11.3 ± 0.8 | 24 ± 3 |
| CNF:Alginate 90:10 Cu²⁺ | 10.9 ± 0.3 | 276 ± 14 | 8.7 ± 1.0 | 16 ± 3 |
| CNF:Alginate 90:10 Nd³⁺ | 11.0 ± 0.4 | 275 ± 11 | 8.8 ± 0.7 | 17 ± 3 |
| CNF:Alginate 70:30 Ca²⁺ | 9.9 ± 0.2 | 255 ± 8 | 9.0 ± 0.5 | 17 ± 1 |
| CNF:κ-carr 70:30 | 8.7 ± 0.1 | 227 ± 9 | 10.2 ± 1.0 | 15 ± 2 |
| CNF:κ-carr 70:30 K⁺ | 9.8 ± 0.4 | 255 ± 18 | 10.4 ± 1.0 | 19 ± 3 |
| CNF:κ-carr 70:30 Ca²⁺ | 10.0 ± 0.1 | 239 ± 7 | 8.9 ± 0.7 | 15 ± 1 |
| CNF:ι-carr 70:30 | 7.9 ± 0.2 | 216 ± 9 | 11.1 ± 1.0 | 16 ± 2 |
| CNF:ι-carr 70:30 K⁺ | 10.1 ± 0.2 | 254 ± 8 | 9.0 ± 0.5 | 16 ± 1 |
| CNF:ι-carr 70:30 Ca²⁺ | 9.1 ± 0.3 | 245 ± 15 | 10.1 ± 1.2 | 17 ± 2 |

Alginate Ca²⁺ = alginate material treated with calcium chloride; CNF Ca²⁺ = CNF material treated with calcium chloride; CNF Hot-pressed = hot-pressed CNF material; CNF:Alg 90:10 Ca²⁺ = 90 wt % CNF and 10 wt % alginate treated with CaCl₂; CNF:Alg 90:10 Cu²⁺ = 90 wt % CNF and 10 wt % alginate treated with Cu(NO₃)₂; CNF:Alg 90:10 Nd³⁺ = 90 wt % CNF and 10 wt % alginate treated with NdCl₃; CNF:Alg 70:30 Ca²⁺ = 70 wt % CNF and 30 wt % alginate treated with CaCl₂; CNF:κ-Carr 70:30 = 70 wt % CNF and 30 wt % κ-carrageenan; CNF:κ-Carr 70:30 K⁺ = 70 wt % CNF and 30 wt % κ-carrageenan treated with KCl; CNF:κ-Carr 70:30 Ca²⁺ = 70 wt % CNF and 30 wt % κ-carrageenan treated with CaCl₂; CNF:ι-carr 70:30 = 70 wt % CNF and 30 wt % ι-carrageenan; CNF:ι-carr 70:30 K⁺ = 70 wt % CNF and 30 wt % ι-carrageenan treated with KCl; and CNF:ι-carr 70:30 Ca²⁺ = 70 wt % CNF and 30 wt % ι-carrageenan treated with CaCl₂.

The addition of polymers to CNF nanopapers usually leads to a loss of stiffness while extensive crosslinking makes the material stiffer but at the same time more brittle. FIGS. 3 and 4, and Table 3 shows that the addition of 10% alginate to CNF to prepare a 90:10 CNF:alginate film did not affect the dry material properties significantly and, when the films were crosslinked with calcium ions, the CNF:alginate Ca²⁺ composite showed an increase in stiffness and in the strain-at-break with a modulus around 10.5 GPa, a tensile strength above 300 MPa, and the work of fracture approaching 25 MJ m⁻³ (FIGS. 3 and 4), which are impressive properties in terms of unoriented film composites that rarely reach strengths close to or above 300 MPa at 50% RH. The 70:30 CNF:alginate Ca²⁺ composite and the 90:10 CNF:alginate composites crosslinked with copper or neodymium ions, however, resulted in more brittle materials in the dry state.

Oxygen Permeability

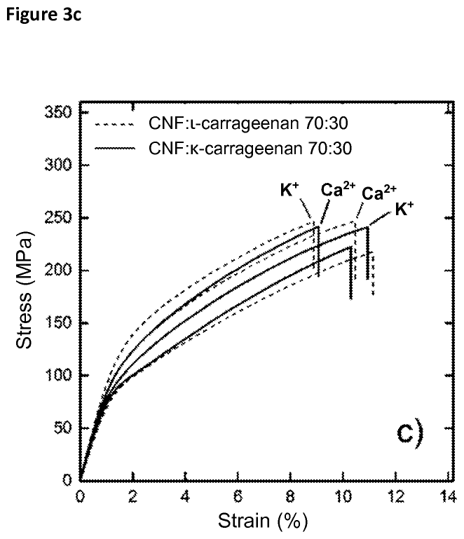

FIG. 5, presents the oxygen permeability data at 50 and 80% relative humidity, for CNF:alginate 90:10 crosslinked with calcium ions , pristine CNF nanopaper and pristine CNF nanopaper treated with calcium ions and shows that the Ca²⁺ treated composite with 10% alginate was a slightly better barrier than the reference CNF or the calcium-treated CNF at 50% relative humidity, probably because the flexible alginate makes the material denser and more uniform. At 80% relative humidity the permeability of the CNF sample increased drastically, whereas the calcium treated nanopapers were slightly more stable.

### Example2

### Importance of the Interpenetrating Networks Formed with Different Treatments

Materials

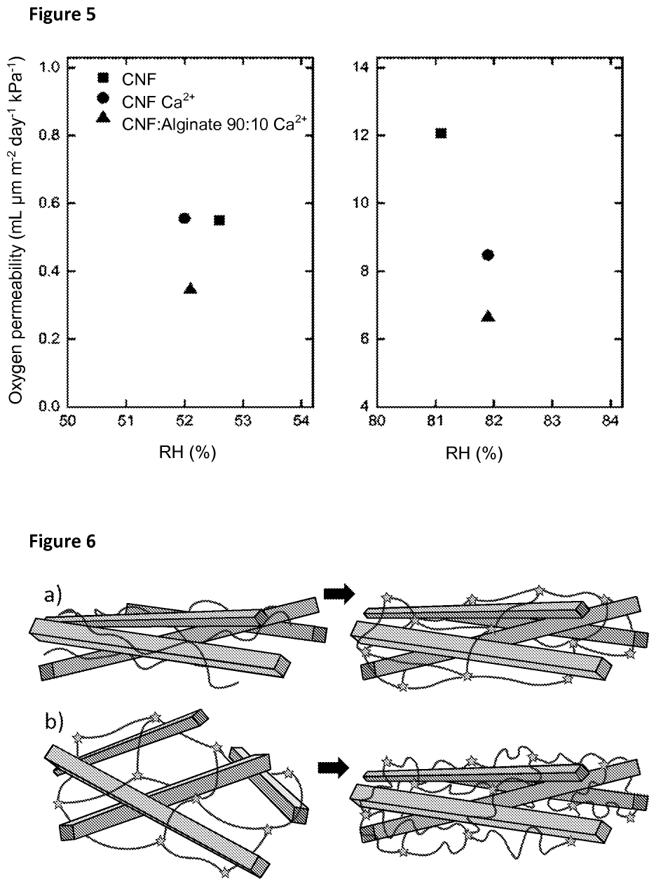

CNF:alginate materials were prepared following two different routes in order to evaluate the importance of the interpenetrating networks. In the first one the alginate network was formed while the CNF was in a swollen state (with a lot of voids between physically locked fibrils) and in the other, the alginate network was formed while the CNF was dry, i.e. in a collapsed state. The first material was crosslinked by introducing calcium ions to the never-dried CNF:alginate filter cake in its swollen state in Milli-Q water, and the second material was crosslinked by first drying the CNF:alginate film, to collapse the structure and reduce the amount of voids between the fibrils, before introducing calcium ions. Reference samples of CNF films treated with calcium ions when the film was dry, and in a swollen state, respectively, were also prepared. The tensile mechanical properties in the wet state were tested for all the samples (FIG. 7 and Table 4).

Preparation of CNF:alginate Ca²⁺ Crosslinked from Dry Film:

A 0.2 wt % dispersion CNF was mixed with a ˜0.2 wt % alginate solution at a ratio 90:10 CNF:alginate. The sample was mixed to a volume of 200 mL and about 0.2 wt % total solid content, using the ultra-turrax for 9 min at 9000 rpm. The dispersion (400 mg dry weight) was filtered through a Durapore Membrane Filter (PVDF, Hydrophilic, 0.65 μm) in a Kontes microfiltration assembly with a filter diameter of 8 cm. The 1-2 mm wet gel that was formed after the filtration was dried for 20 min at 92° C. and at a reduced pressure of 95 kPa using the drying section of a Rapid Köthen sheet former (Paper Testing Instruments, Austria). The dried film was 50-60 μm thick. The dried film was then soaked in 1 wt % CaCl₂ (>97%, Sigma Aldrich) solution for 24 hours in order to crosslink the composite material and the composite film was then rinsed in Milli-Q water for 24 hours. Thereafter the wet tensile testing was performed on these wet films.

Preparation of CNF:alginate Ca²⁺ Crosslinked from Never-Dried Film (Swollen Film):

A 0.2 wt % dispersion CNF was mixed with a ˜0.2 wt % alginate solution at a ratio 90:10 CNF:alginate. The sample was mixed to a volume of 200 mL and about 0.2 wt % total solid content, using the ultra-turrax for 9 min at 9000 rpm. The dispersion (400 mg dry weight) was filtered through a Durapore Membrane Filter (PVDF, Hydrophilic, 0.65 μm) in a Kontes microfiltration assembly with a filter diameter of 8 cm. The 1-2 mm wet gel that was formed after the filtration (filter cake) was allowed to swell in Milli-Q water and then soaked in 1 wt % CaCl₂ (>97%, Sigma Aldrich) solution for 24 hours in order to crosslink the composite material in its swollen state. Thereafter the crosslinked material was rinsed in Milli-Q water for 24 hours.

At this state, the material still had a consistency of a gel and it was not possible to measure the properties with a wet tensile test (it would fall apart); therefore the material was dried with a Rapid Köthen, and a film was obtained. Then, in order to make the wet tensile test, the film was soaked in milli-Q water for 24 hours prior to testing.

Preparation of Pristine CNF Film Treated with Ca²⁺ from Dry Film:

Pristine CNF films were prepared by filtrating a 0.2 wt % CNF dispersion (400 mg dry weight) through a Durapore Membrane Filter (PVDF, Hydrophilic, 0.65 μm) in a Kontes microfiltration assembly with a filter diameter of 8 cm. The wet gel that was formed after the filtration was dried for 20 min at 92° C. and at a reduced pressure of 95 kPa using the drying section of a Rapid Köthen sheet former. The dried CNF nanopaper was then soaked in 1 wt % CaCl₂ (>97%, Sigma Aldrich) solution for 24 hours and then rinsed in Milli-Q water for 24 hours. Thereafter the wet tensile testing was performed on this wet nanopaper CNF Ca²⁺.

Preparation of Pristine CNF Film Treated with Ca²⁺ from Never-Dried Film:

Pristine CNF films were prepared by filtrating a 0.2 wt % CNF dispersion (400 mg dry weight) through a Durapore Membrane Filter (PVDF, Hydrophilic, 0.65 μm) in a Kontes microfiltration assembly with a filter diameter of 8 cm. The wet gel that was formed after the filtration was then soaked in 1 wt % CaCl₂ (>97%, Sigma Aldrich) solution for 24 hours and then rinsed in Milli-Q water for 24 hours. Thereafter the CNF material was dried with a Rapid Köthen, and a CNF nanopaper was obtained. Then, in order to make the wet tensile test the nanopaper was soaked in milli-Q water for 24 hours prior to testing.

Results

Mechanical Properties in Wet State

The tensile mechanical properties were tested in the wet state in order to understand the importance of the interpenetrating networks (FIG. 7 and Table 4).

TABLE 4

| | Young's | Tensile | Strain at | Work of |
|---|---|---|---|---|
| | modulus | strength | break | fracture |
| Sample (wet state) | (MPa) | (MPa) | (%) | (MJm⁻³) |
| CNF Ca²⁺ dry film | 62 ± 5 | 8.0 ± 0.5 | 40 ± 2 | 1.8 ± 0.2 |
| CNF Ca²⁺ swollen film | 37 ± 2 | 3.7 ± 0.4 | 40 ± 3 | 0.9 ± 0.1 |
| CNF:Alg 90:10 Ca²⁺ dry film | 135 ± 5 | 17 ± 1 | 56 ± 2 | 5.0 ± 0.4 |
| CNF:Alg 90:10 Ca²⁺ swollen film | 32 ± 3 | 3.3 ± 0.2 | 37 ± 2 | 0.7 ± 0.1 |

CNF Ca²⁺ dry film = Dry CNF material treated with calcium chloride; CNF Ca²⁺ swollen film = CNF material treated with calcium chloride when in gel or swollen state; CNF:Alg 90:10 Ca²⁺ dry film= dried film comprising 90 wt % CNF and 10 wt % alginate, as calculated on the dry weight of CNF and alginate before treatment with CaCl₂, treated with CaCl₂; CNF:Alg 90:10 Ca²⁺ = 90 wt % CNF and 10 wt % alginate treated with CaCl₂ when in gel or swollen state.

The wet mechanical properties of the samples produced in the swollen state were both worse than their equiparative samples that were dried before crosslinking. In fact, the CNF:Alg 90:10 Ca²⁺ swollen film had even inferior wet mechanical properties than the CNF references, which indicates that the state in which the alginate networks are formed by the introduction of counter-ions is vital (FIGS. 6 and 7). In that case (CNF:Alg 90:10 Ca²⁺ swollen film), the alginate network was adapted to the swollen state, and would later be collapsed (during the drying of the gel to form a film) and have little influence on the material properties when the CNF network was formed during drying. The same trend was observed with the reference CNF nanopaper when the calcium was introduced in the swollen gel state, and this suggests that proximity is crucial for the crosslinking mechanism for CNF using multivalent ions.

CNF:Alg 90:10 Ca²⁺ swollen film showed a greater relative swelling thickness of 5.9, compared to 4.8 for the similarly treated reference CNF nanopaper. This and the more drastic relative reduction in the stiffness and extensibility, compared to that CNF:Alg 90:10 Ca²⁺ dry film, show that the influence of the alginate was more or less removed when a network adapted for the swollen gel state was formed (FIGS. 6 and 7).

### Example 3

### Comparison Different CNF:Alginate Ratios Materials

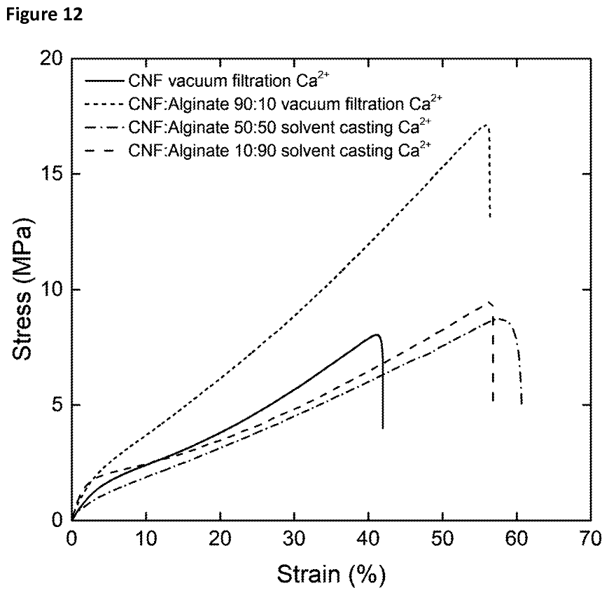

Films of CNF:alginate composites crosslinked with calcium ions and with ratios 90:10, 50:50 and 10:90 parts per weight of CNF to alginate, were prepared in order to investigate the influence of the CNF:alginate ratio on the mechanical properties in wet state of the composite materials (FIG. 12).

Preparation of CNF:Alginate 90:10 Ca²⁺ Composite Films:

The films were prepared as described in Example 1.

Preparation of CNF Ca²⁺ Nanopaper:

The reference nanopaper was prepared as described in Example 1.

Preparation of CNF:Alginate 50:50 and 10:90 Films Crosslinked with Ca²⁺:

A 0.2 wt % dispersion CNF was mixed with a ˜0.4 wt % alginate solution at various CNF:alginate ratios (50:50 and 10:90). The dispersion (700 mg dry weight) was mixed using an ultra-turrax for 9 min at 9000 rpm, degassed and then solvent casted in PTFE cups with a diameter of 9.5 cm. The solvent casting took around 2 weeks until the films were dried. The dried films were then soaked in 1 wt % CaCl₂ solution for 24 hours to crosslink the composite material. Thereafter the composite films were rinsed in Milli-Q water for 24 hours. These films could not be prepared by filtration method because the retention of the alginate is too low at high alginate content. The solvent casted films presented a very inhomogeneous thickness.

Results

Film Preparation and Appearance

While the composites films prepared from CNF:alginate 90:10 and 70:30 had a very uniform and homogeneous appearance, the solvent casted CNF:alginate films with ratio 50:50 and 10:90 presented a very inhomogeneous appearance and varying thickness along the film. These films (50:50 and 10:90) could not be prepared by filtration method due to low retention of the alginate. Solvent casting is not a preferable method for the preparation of CNF:alginate composite films, both due to the properties of the films obtained and because solvent casting is time-consuming (1-2 weeks compared to 12-24 hours for vacuum filtration).

Mechanical Properties in Wet State

The results of the wet mechanical test can be seen in FIG. 12 and Table 5.

TABLE 5

| | Young's | Tensile | Strain at | Work of |
|---|---|---|---|---|
| | modulus | strength | break | fracture |
| Sample (wet state) | (MPa) | (MPa) | (%) | (MJm⁻³) |
| CNF Ca²⁺ | 62 ± 5 | 8.0 ± 0.5 | 40 ± 2 | 1.8 ± 0.2 |
| CNF:Alg 90:10 Ca²⁺ | 135 ± 5 | 17 ± 1 | 56 ± 2 | 5.0 ± 0.4 |
| CNF:Alg 50:50 Ca²⁺ | 70 ± 5 | 8.7 ± 0.8 | 62 ± 7 | 3.0 ± 0.5 |
| CNF:Alg 10:90 Ca²⁺ | 118 ± 11 | 9.1 ± 1.2 | 58 ± 8 | 2.8 ± 0.7 |

CNF Ca²⁺ = pristine CNF nanopaper treated with calcium ions; CNF:Alg 90:10 Ca²⁺ = 90:10 parts per weight of CNF to alginate, treated with CaCl₂; CNF:Alg 50:50 Ca²⁺ = 50:50 CNF:alginate, treated with CaCl₂; CNF:Alg 10:90 Ca²⁺ = 10:10 CNF:alginate, treated with CaCl₂

In the wet state, the composites CNF:alginate Ca²⁺ prepared with ratios 90:10 and 70:30 showed significantly better tensile properties than what would have been expected for a proportional combination of the material properties of the individual components. This was not the case for the composites CNF:alginate Ca²⁺ prepared with ratios 50:50 and 10:90. Due to the inhomogeneity of the films obtained by solvent casting, the results obtained from one sample to another (tensile samples prepared from the same composite film) could differ drastically.

### Example 4

### Mechanical Properties of CNF:Alginate 90:10 Composite Crosslinked with Different Ions

Materials

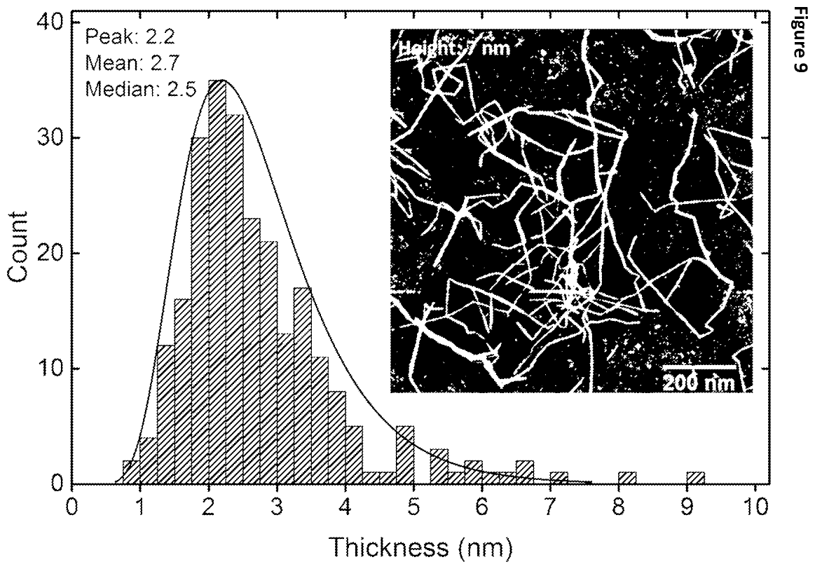

Films of CNF:alginate composites were treated with different ions (i.e. Ca²⁺, Cu²⁺, Fe³⁺) and the mechanical properties in wet state of the different materials were investigated (FIG. 10).

CNF Preparation

A 2 wt % CNF gel was kindly provided by RISE bioeconomy (former Innventia), Stockholm, Sweden. The CNF was derived from a dissolving grade pulp that had been carboxymethylated to a charge density between 500-600 μmol/g prior to the defibrillation. The gel was further homogenised using a microfluidizer by three passes through a serial 200-100 chamber configuration, diluted to a dry content of 0.2 wt % at a volume of 900 mL, dispersed using ultra-turrax at 13000 rpm for 20 minutes, and sonicated with a 6mm microtip probe at 30% amplitude for 10 minutes. The gel was centrifuged at 4100×g for 1 h to remove larger aggregates or flocs.

Alginate Preparation

A 0.2 wt % alginate solution was prepared in the same way as described in Example 1.

Preparation of CNF/Alginate 90:10 and Crosslinked with Different Ions:

A 0.2 wt % dispersion CNF was mixed with a ˜0.2 wt % alginate solution at a ratio 90:10 CNF:alginate. The sample was mixed to a volume of 200 mL and about 0.2 wt % total solid content, using the ultra-turrax for 9 min at 9000 rpm. The dispersion (400 mg dry weight) was filtered through a Durapore Membrane Filter (PVDF, Hydrophilic, 0.65 μm) in a Kontes microfiltration assembly with a filter diameter of 8 cm. The 1-2 mm wet gel that was formed after the filtration was dried for 20 min at 92° C. and at a reduced pressure of 95 kPa using the drying section of a Rapid Köthen sheet former (Paper Testing Instruments, Austria). The dried film was 50-60 μm thick. The dried film was then soaked in either 1 wt % CaCl₂, 1 wt % CuCl₂ or 1 wt % FeCl₃ solution for 24 hours in order to crosslink the composite material and the composite film was then rinsed in Milli-Q water for 24 hours. Thereafter the wet tensile testing was performed on these wet films.

Results

Tensile Mechanical Properties in Wet State

The obtained results can be seen in FIG. 10 and Table 6

TABLE 6

| | Young's | Tensile | Strain at | Work of |
|---|---|---|---|---|
| | modulus | strength | break | fracture |
| Sample (wet state) | (MPa) | (MPa) | (%) | (MJm⁻³) |
| CNF:Alg 90:10 Ca²⁺ | 111 ± 5 | 13 ± 2 | 53 ± 6 | 3.6 ± 0.7 |
| CNF:Alg 90:10 Cu²⁺ | 266 ± 9 | 19 ± 3 | 47 ± 6 | 4.9 ± 1.1 |
| CNF:Alg 90:10 Fe³⁺ | 917 ± 71 | 31 ± 2 | 26 ± 2 | 5.4 ± 0.7 |

CNF:Alg 90:10 Ca²⁺ = 90:10 parts per weight of CNF to alginate treated with CaCl₂;
CNF:Alg 90:10 Cu²⁺ = 90:10 parts per weight of CNF to alginate treated with CuCl₂;
CNF:Alg 90:10 Fe³⁺ = 90:10 parts per weight of CNF to alginate treated with FeCl₃;

All the CNF:alginate composite material presented great properties in the wet tensile test. In FIG. 10 it is shown how different ions affected the tensile properties of CNF:alginate 90:10 composite films in the wet state, where Fe³⁺ has an impressive effect on the Young modulus and tensile strength. The CNF:alginate 90:10 composite crosslinked with Fe³⁺ became significantly stiffer with lower strain at break than the other composite films treated with Ca²⁺ and Cu²⁺.

### Example 5

### Dry-Reswell Effect on Composite

Materials

Composite films of CNF:alginate 90:10 crosslinked with Fe³⁺ were produced following the procedures described in Example 4. According to those procedures, the films are rinsed after being treated with the Fe³⁺ ions (in order to remove the excess of ions) and the tensile mechanical properties of these wet samples were measured in that wet state (FIG. 11). In this example, after rinsing the films in milli-Q water, the films were dried one more time with the Rapid Köthen and reswelled thereafter by soaking the films in milli-Q water for 24 hours.

Results

Tensile Mechanical Properties in Wet State

The tensile mechanical properties of these dried and reswelled samples were measured and the results can be seen in FIG. 11 and Table 7.

TABLE 7

| | Young's | Tensile | Strain at | Work of |
|---|---|---|---|---|
| | modulus | strength | break | fracture |
| Sample (wet state) | (MPa) | (MPa) | (%) | (MJm⁻³) |
| CNF:Alg 90:10 Fe³⁺ original wet | 917 ± 71 | 31 ± 2 | 26 ± 2 | 5.4 ± 0.7 |
| CNF:Alg 90:10 Fe³⁺ dried and | 1314 ± 28 | 40 ± 2 | 19 ± 4 | 5.0 ± 1.1 |
| reswelled | | | | |

CNF:Alg 90:10 Fe³⁺ original wet = 90:10 parts per weight of CNF to alginate treated with Fe³⁺ ions and never dried after the ion treatment; CNF:Alg 90:10 Fe³⁺ dried and reswelled = 90:10 parts per weight of CNF to alginate treated with Fe³⁺ ions which has been thereafter dried and reswelled in milli-Q water for 24 hours prior to mechanical testing;

As it can be seen from the results, by drying and reswelling the composite films, the wet mechanical properties became even better, reaching a Young modulus of 1.3 GPa for the CNF:alginate 90:10 Fe³⁺ that was dried and reswelled.

### Example 6

### Effect of Ion Crosslinking Time

Materials

CNF Preparation

A 2 wt % CNF gel was kindly provided by RISE bioeconomy (former Innventia), Stockholm, Sweden. The CNF was derived from a dissolving grade pulp that had been carboxymethylated to a charge density between 500-600 μmol/g prior to the defibrillation. The gel was further homogenised using a microfluidizer by two passes through a serial 200-100 chamber configuration, diluted to a dry content of 0.2 wt % at a volume of 900 mL, dispersed using ultra-turrax at 13000 rpm for 20 minutes. The gel was centrifuged at 4100×g for 1 h to remove larger aggregates or flocs.

Alginate Preparation

A 0.2 wt % alginate solution was prepared in the same way as described in Example 1.

Preparation of CNF:Alginate 90:10 and Crosslinked for Different Time Periods:

A 0.2 wt % dispersion CNF was mixed with a ˜0.2 wt % alginate solution at a ratio of 90:10 CNF:alginate. The sample was mixed to a volume of 200 mL and about 0.2 wt % total solid content, using the ultra-turrax for 9 min at 9000 rpm. The dispersion (400 mg dry weight) was filtered through a Durapore Membrane Filter (PVDF, Hydrophilic, 0.65 μm) in a Kontes microfiltration assembly with a filter diameter of 8 cm. The 1-2 mm wet gel that was formed after the filtration was dried for 20 min at 92° C. and at a reduced pressure of 95 kPa using the drying section of a Rapid Köthen sheet former (Paper Testing Instruments, Austria). The dried film was 50-60 μm thick. The dried film was then soaked in 1 wt % CaCl₂ solution for either 3 minutes, 30 minutes or 3 hours in order to crosslink the composite material. The composite film was then rinsed in Milli-Q water for 24 hours. Thereafter the wet tensile testing was performed on these wet films.

Results

Tensile Mechanical Properties in Wet State

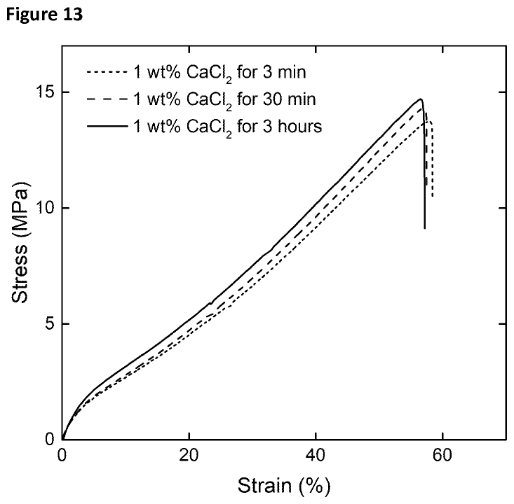

The obtained results can be seen in FIG. 13 and Table 8

TABLE 8

| | Young's | Tensile | Strain at | Work of |
|---|---|---|---|---|
| | modulus | strength | break | fracture |
| Sample (wet state) | (MPa) | (MPa) | (%) | (MJm⁻³) |
| CNF:Alg 90:10 Ca²⁺ 3 min | 94 ± 10 | 14 ± 1 | 56 ± 5 | 4.1 ± 0.6 |
| CNF:Alg 90:10 Ca²⁺ 30 min | 100 ± 12 | 14 ± 1 | 57 ± 5 | 4.2 ± 0.7 |
| CNF:Alg 90:10 Ca²⁺ 3 h | 87 ± 23 | 14 ± 1 | 56 ± 4 | 4.1 ± 0.4 |

CNF:Alg 90:10 Ca²⁺ 3 min = 90:10 parts per weight of CNF to alginate treated with CaCl₂ for 3 minutes; CNF:Alg 90:10 Ca²⁺ 30 min = 90:10 parts per weight of CNF to alginate treated with CaCl₂ for 30 minutes; CNF:Alg 90:10 Ca²⁺ 3 h = 90:10 parts per weight of CNF to alginate treated with CaCl₂ for 3 hours

All the CNF:alginate composite material presented great mechanical properties in the wet tensile test, even when the material had been treated with CaCl₂ for only 3 minutes. The tensile strength and strain at break are the same as when the same composite material is treated with CaCl₂ for 24 hours (Table 5 and Table 6).

1. A composite material comprising 65-99 wt % cellulose nanofibers (CNF), and 0.5-30 wt % of an anionic gelling polysaccharide, as calculated by dry weight of the composite material.

2. A composite material according to claim 1, wherein the material comprises 70-99 wt % cellulose nanofibers (CNF), and 1-30 wt % of an anionic gelling polysaccharide, as calculated by dry weight of the composite material.

3. A composite material according to claim 1, wherein the material has a wet tensile strength of at least 10 MPa and a Young's modulus under tension of at least 75 MPa when the material has been soaked in water for at least 24 hours.

4. A composite material according to claim 1, wherein the material does not swell more than 3.5 times its original thickness when the material is soaked in water for 24 hours.

5. A composite material according to claim 1, wherein the gelling polysaccharide is alginate.

6. A composite material according to claim 1, wherein the composite material further comprises multivalent metal or metalloid ions.

7. A composite material according to claim 6, wherein the multivalent metal or metalloid ions forms crosslinks in the material.

8. (canceled)

9. A composite material according to claim 7, wherein the ions are divalent ions.

10. A composite material according to claim 9, wherein the divalent ions are calcium ions.

11. A composite material according to claim 7, wherein the ions are trivalent ions.

12. A composite material according to claim 11, wherein the trivalent ions are iron ions.

13. A composite material according to claim 1, wherein the composite material is a film having a thickness of 1-1000 μm, when dried and conditioned at 50% RH and 23° C.

14. (canceled)

15. A composite material according to claim 1, wherein the composite material in a dry state has a tensile strength of at least 250 MPa and a Young's modulus under tension of at least 9.5 GPa at 50% RH and 23° C.

16. A composite material according to claim 1, wherein the composite material has a Young's modulus under tension in the wet state of at least 125 MPa when the material is soaked in water for at least 24 hours.

17. A composite material according to claim 1, wherein the composite material has work of fracture of at least 3 MJm⁻³ in the wet state.

18. A composite material according to claim 1, comprising less than 70 wt % water as calculated on the total weight of the composite material.

19. A composite material according to claim 1, wherein the composite material has an oxygen permeability that is lower than 0.5 cm³·μm·m⁻²·day⁻¹·kPa⁻¹, at 50% RH and 23° C.

20. A method for the preparation of a composite material according to claim 1, wherein the method comprises the steps of:
a) mixing a CNF suspension with an anionic gelling polysaccharide to obtain a dispersion with 70-99 wt % of CNF and 1-30 wt % of the gelling polysaccharide, as calculated on the dry weight of the dispersion;
b) removing a dispersing medium wherein the CNF and anionic gelling polysaccharide are dispersed to obtain an object comprising of CNF, anionic gelling polysaccharide and less than 20 wt % water as calculated on the total weight of the obtained object;
c) soaking the object obtained in step b) in a solution comprising multivalent metal or metalloid ions to obtain the composite material in a soaked state.

21. A method according to claim 20, further comprising a step d) of forming the composite material in c) into a desired shape.

22. A method according to claim 20, further comprising the step of drying the composite material obtained in step c) or d) to obtain an object that is also stable in water.

23.-30. (canceled)
